(19) United States
(12) Patent Application Publication
(10) Pub. No.: US 2010/0086901 A1
(43) Pub. Date: Apr. 8, 2010

(54) WORLD WIDE REPOSITIONING AND MONITORING TOOL FOR SIMULATED VEHICLE

(76) Inventor: Gary R. Fogle, Seattle, WA (US)

Correspondence Address: Hayes Soloway P.C., 3450 E. Sunrise Drive, Suite 140, Tucson, AZ, 85718, US

(21) Appl. No.: 12/247,159

(22) Filed: Oct. 7, 2008

(51) Int. Cl. G09B 9/00

(52) U.S. Cl. 434/30

(57) ABSTRACT

A world-wide repositioning and monitoring tool for a simulated vehicle combining the features of a virtual globe or other geographic information systems (GIS) database with a navigation database allowing the operator expanded capability in terms of selecting specific or random points for relocation, eliminating the need for tedious operator input regarding points outside of the limited navigation database, and allowing a graphic monitoring tool to view and record the geographic position of the simulated vehicle.

### FIELD

The present disclosure is generally related to vehicle simulation systems and, more particularly, in repositioning and monitoring of simulated vehicles. The invention has particular utility for use with vehicle simulation, in particular flight simulation and will be described in connection with such utility, although other utilities are contemplated.

### BACKGROUND

Vehicle simulation, flight simulation in particular, is a multi-million dollar industry and its application has spread beyond training exercises to encompassing a range of analytical functions. As the operating systems of aircraft and other vehicles increase in complexity and are manufactured by a growing number of vendors, it has become necessary to adopt testing procedures for all types of instrumentation and other equipment in a simulated environment early in the design process. For example, individual components are tested first individually, then as part of a subsystem, before being tested as part of a larger integrated system and ultimately being incorporated into the vehicle itself.

The effectiveness of such exhaustive testing procedures is, in part, dependent on the degree of realism with which the simulation is performed. Another important element that determines the value of the simulation is the degree of control and the ease with which the operator can set up a particular scenario. One specific area in which the ease and realism in operating simulated vehicles can be improved is in the global repositioning and monitoring of the simulated vehicle. Repositioning and monitoring of a simulated vehicle may be crucial, for example, to the testing of navigation devices, other avionics, accident investigations, training exercises, and customer demonstrations.

Current repositioning of simulated vehicles requires the entry of discrete latitude, longitude and altitude points which are gathered and placed in a file. FIG. 1 shows a screen shot of an interface currently used in the repositioning of simulated vehicles. Specific points of interest may be gathered from a navigation database (such as a Jeppesen NAVDATA™ as provided by Jeppesen Sanderson, Inc. and others). In order to select other data points, the operator must calculate the latitude and longitude from another source. This generally is very tedious and may not yield accurate results. These points are loaded to reposition the simulated vehicle.

Current visualization tools are primarily focused on the vehicle or out the window, providing limited earth views. These models do not provide a planar map that allows monitoring of the vehicle location. Flight simulator pilots are often asked to determine the vehicle location.

### SUMMARY

The present disclosure provides a world-wide repositioning and monitoring tool for a simulated vehicle that improves upon the prior art by providing a graphic interface allowing the operator expanded capability in terms of selecting specific or random points for relocation, eliminating the need for tedious operator input regarding points outside of the limited navigation database, and allowing a graphic monitoring tool to view and record the geographic position of the simulated vehicle.

One aspect of the present disclosure provides a method for graphically repositioning and monitoring the location of a simulated vehicle, comprising selecting a point using a graphic interface of a computer application, wherein the computer application determines the geographic location of the selected point and communicates data regarding the geographic location of the selected point to a simulation daemon, whereupon the simulation daemon processes the data and causes the repositioning of the simulated vehicle to occur.

In another aspect, the present disclosure provides a system for repositioning and monitoring the location of a simulated vehicle, comprising a computer application using a virtual globe or other geographic information systems database and having an overlay of a navigation database, the computer application having a graphic interface, wherein the computer application can accept an input from a user through the graphic interface for selecting a repositioning point, whereupon the computer application communicates the repositioning point to a simulation daemon that allows the repositioning of the simulated vehicle.

In yet another aspect, the present disclosure provides an article of manufacture comprising an information storage medium having computer readable code disposed therein and usable with a computer processor for repositioning and monitoring the location of a simulated vehicle. The computer processor includes a virtual globe or other geographic information systems database, the computer processor having a graphic interface, wherein the computer processor can accept an input from a user through the graphic interface for selecting a repositioning point, whereupon the computer processor communicates the repositioning point to a simulation daemon that allows the repositioning of the simulated vehicle.

Other systems, methods, features, and advantages of the present disclosure will be or become apparent to one with skill in the art upon examination of the following drawings and detailed description. The features, functions and advantages that have been discussed can be achieved independently in various embodiments of the present invention or may be combined in yet other embodiments further details of which can be seen with reference to the following description and drawings.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a depiction of an operator interface for a repositioning and monitoring tool according to the prior art;

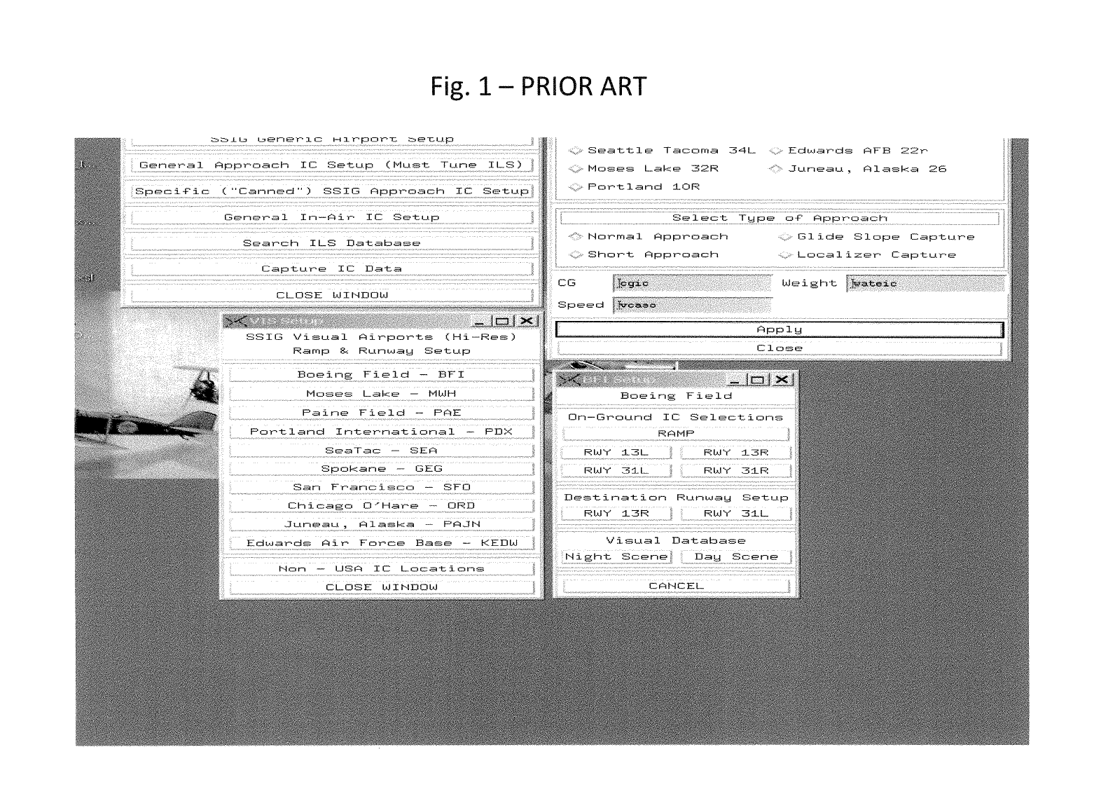

FIG. 2 is an illustration of an operator interface for a repositioning and monitoring tool in accordance with the present disclosure;

FIG. 3 is a depiction of the operator interface of FIG. 2, zoomed in on the location of a simulated vehicle;

FIG. 4 is a further depiction of the operator interface of FIG. 2; and

FIGS. 5A and 5B are a flow diagrams displaying the repositioning and monitoring functions, respectively, of a world-wide repositioning and monitoring tool in accordance with the present disclosure.

### DETAILED DESCRIPTION

The present disclosure provides a method and system tool for repositioning and monitoring a simulated vehicle. The repositioning and monitoring tool improves upon the prior art by using a virtual globe, such as for example GOOGLE EARTH™, or other geographic information systems (GIS) database as an overlay with a navigation database, such as for example JEPPESEN NAVDATA™. The operability of the method and system tool of the present disclosure increases from a relatively few discrete simulated repositioning points under the prior art method and system to world-wide and virtually continuous capability. This significantly reduces the burden on the operator in determining coordinate locations from random sources for instrument testing.

The method and system tool of the present disclosure allows the simulation operator to reposition and monitor the simulated vehicle relative to terrestrial maps, landmarks, and/or navigation database overlays (including airways, waypoints, etc.) and imports the functionality of virtual globe programs such as pan, zoom, drag, search, and other features. For example, the simulation operator may drag the simulated vehicle along a continuous line or jump to a specific point in the navigation database with equal precision.

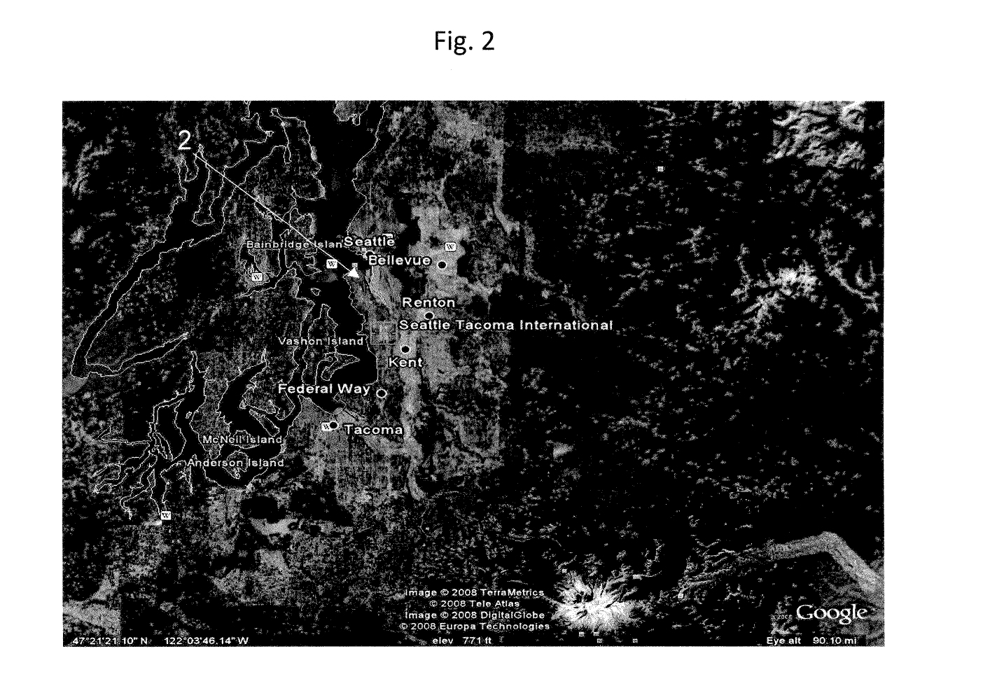

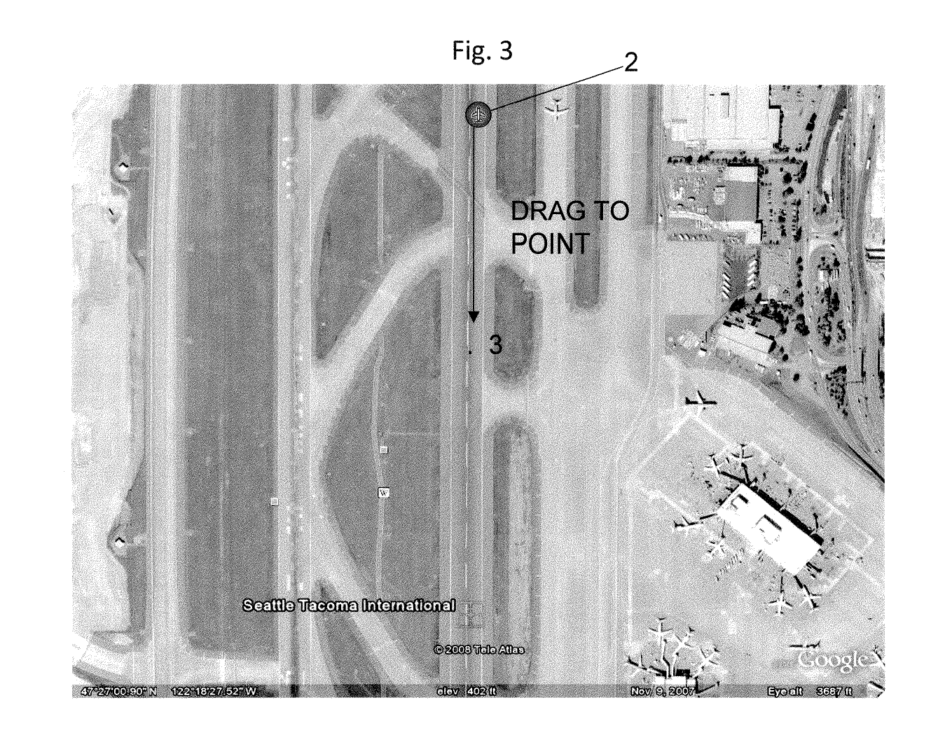

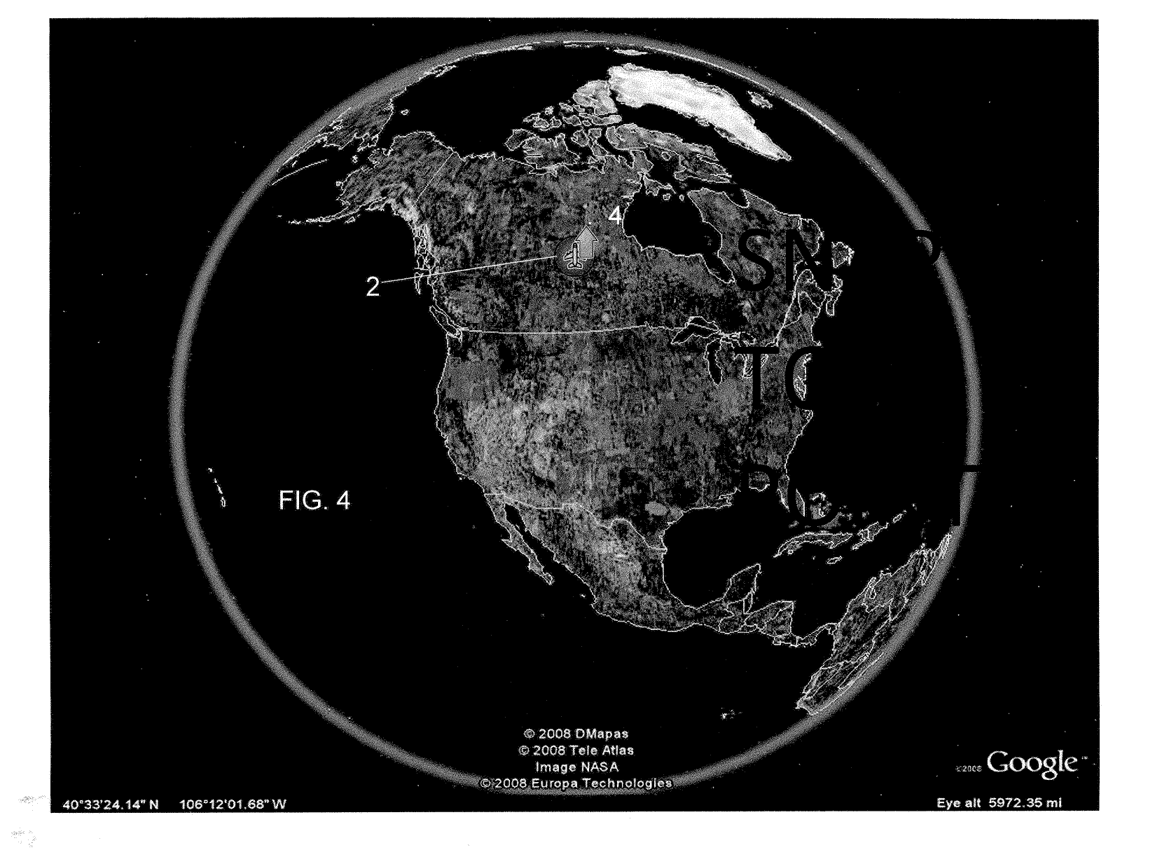

FIGS. 2-3 depict the display of the application of the present disclosure showing the location of a simulated vehicle 2 on the earth view, where FIG. 3 shows the same location substantially “zoomed in”. FIG. 3 further demonstrates the capability of the application allowing the operator to “drag” the simulated vehicle to a new location 3 using a mouse or other input device. The user may also select a new location for the simulated vehicle and “snap to point”, wherein the simulated vehicle is immediately relocated to the selected location. For example, referring to FIG. 4, upon selecting new location 4, the simulated vehicle 2 is immediately relocated to the new location.

The repositioning and monitoring tool may be operated from a web or desktop application. The application includes a representation of the simulated vehicle within the virtual globe, the monitoring and repositioning of which can be controlled by the operator from the desktop interface. This offers a planar view of earth features relative to the simulated vehicle.

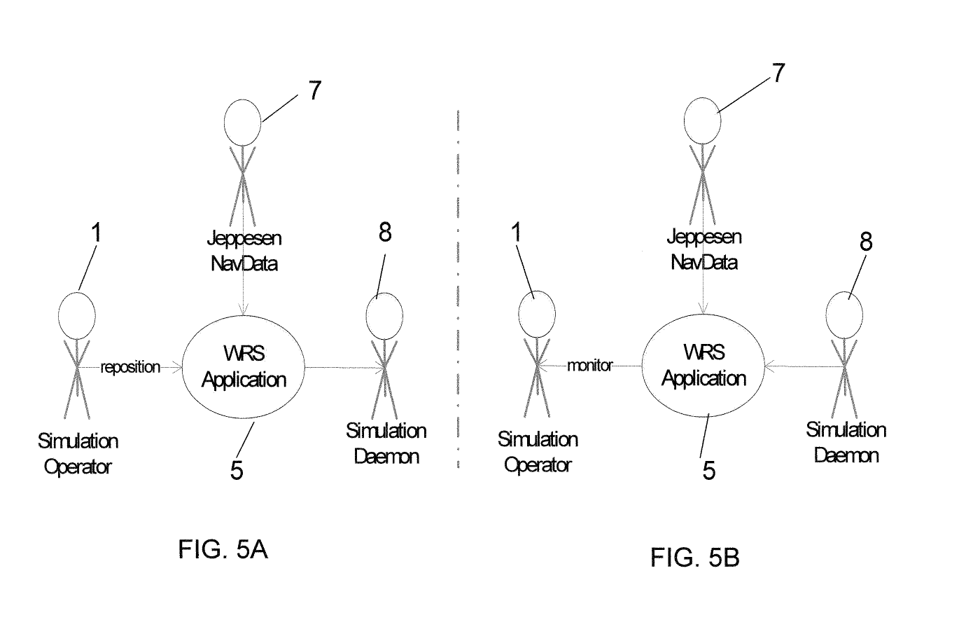

Referring to FIG. 5A, the repositioning may be performed by the operator in a number of ways. The operator 1 may drag the simulated vehicle from point to point, select a specific point in the navigation database 7, or search for a specific point in the virtual globe. Repositioning to a random point is also a capability of the system of the present disclosure. The application 5 will determine the repositioning variables, such as latitude, longitude, and altitude, and enter this information into the simulation daemon 8 as the operator makes the repositioning request according to the methods mentioned above. The simulation daemon then processes these coordinates allowing the repositioning to occur. The repositioning feature of the application is enabled by placing the application in an Initial Conditions mode, other modes being available in an ARINC 610 simulation configuration. The operator can reposition between displayed navigation database airways and/or waypoints.

Referring to FIG. 5B, the monitoring is performed as the simulation daemon 8 returns the geographic coordinates to the application 5, which then processes this information and updates the display for the operator 1. The operator can monitor the simulated vehicle position using either inertial, GPS geographic, or simulation truth coordinates, and can toggle between them.

The navigation database information can be filtered using a selectable range filter. The operator can select a centroid for any filtering operation between the vehicle and display at a selected viewing scale. All data points outside the set range limit are not displayed.

The operator can couple or decouple the vehicle from the application display. When coupled with the display, the earth view follows the vehicle, allowing the operator to watch the lateral progress of the simulated vehicle. If decoupled, the operator can pan the view of the application without repositioning the vehicle. This allows the operator to search and find a new repositioning point without changing the location of the vehicle. This feature will allow the operator to pan the view such that the vehicle may no longer appear on the display. The operator may then toggle the couple/decouple feature to recouple the display to the location of the vehicle, causing the view to immediately return to the location of the vehicle.

Other users may access the application using a web browser. The users would provide login information, specify the host computer, specify the simulated vehicle, and indicate the navigation database. The application uses this information to connect to a simulation and load the navigation database. The user is then given access to monitoring data and repositioning capabilities.

The application is further useful for recording position information. For aircraft simulations, this is done in KML file format (http://www.opengeospacial.org/standards/kml/) to allow processing and display of flight path histories. The operator can activate a flight history including prior flight paths to view the path of flight at any time during or after the simulation.

In an alternative embodiment, the method and system of the present disclosure can utilize the virtual globe without the navigational database overlay and is fully functional.

It should be emphasized that the above-described embodiments of the present disclosure, particularly, any “preferred” embodiments, are merely possible examples of implementations, merely set forth for a clear understanding of the principles of the present disclosure. Many variations and modifications may be made to the above-described embodiments without departing substantially from the spirit and principles of the disclosure. For example, the method and system of the present disclosure may be utilized with other types of simulated vehicles such as automobiles or seafaring vessels. All such modifications and variations are intended to be included herein within the scope of this disclosure and protected by the following claims.

What is claimed is:

1. A method for graphically repositioning and monitoring the location of a simulated vehicle, comprising selecting a point using a graphic interface of a computer application, wherein the computer application determines the geographic location of the selected point and communicates data regarding the geographic location of the selected point to a simulation daemon, whereupon the simulation daemon processes the data and causes the repositioning of the simulated vehicle to occur.

2. The method of claim 1, wherein the point is selected by dragging.

3. The method of claim 1, wherein the point is selected randomly.

4. The method of claim 1, wherein the data includes the latitude and longitude of the geographic location.

5. The method of claim 4, wherein the simulated vehicle is a simulated aircraft.

6. The method of claim 5, wherein the data further includes an altitude of the simulated vehicle.

7. The method of claim 1, wherein the position of the simulated vehicle is monitored using the graphic interface of the computer application, whereupon the simulation daemon periodically communicates a new geographic location of the simulated vehicle to the computer application whereupon the computer application processes the new geographic location and updates the display of the graphic interface.

8. The method of claim 1, wherein the computer application employs a virtual globe or other geographic information systems database.

9. A system for repositioning and monitoring the location of a simulated vehicle, comprising a computer application using a virtual globe or other geographic information systems database, the computer application having a graphic interface, wherein the computer application can accept an input from a user through the graphic interface for selecting a repositioning point, whereupon the computer application communicates the repositioning point to a simulation daemon that allows the repositioning of the simulated vehicle.

10. The system of claim 9, wherein the simulated vehicle is a simulated aircraft.

11. The system of claim 9, wherein the computer application allows the user to drag the simulated vehicle to a new location using the graphic interface.

12. The system of claim 9, wherein the graphic interface may be coupled and decoupled from the location of the simulated vehicle.

13. The system of claim 9, wherein the computer application allows the user to toggle between inertial and GPS geographic coordinates.

14. The system of claim 9, wherein the computer application records historical data related to the position of the simulated vehicle.

15. The system of claim 9, further comprising a navigation database as an overlay for the virtual globe or other geographic information systems database.

16. An article of manufacture comprising an information storage medium having computer readable code disposed thereon and usable with a computer processor for repositioning and monitoring the location of a simulated vehicle, wherein the computer processor includes a virtual globe or other geographic information systems database, the computer processor having a graphic interface, wherein the computer processor can accept an input from a user through the graphic interface for selecting a repositioning point, whereupon the computer processor communicates the repositioning point to a simulation daemon that allows the repositioning of the simulated vehicle.

17. The article of manufacture of claim 16, wherein the simulated vehicle is a simulated aircraft.

18. The article of manufacture of claim 16, wherein the computer processor allows the user to drag the simulated vehicle to a new location using the graphic interface.

19. The article of manufacture of claim 16, wherein the graphic interface may be coupled and decoupled from the location of the simulated vehicle.

20. The article of manufacture of claim 16, further comprising a navigation database as an overlay for the virtual globe or other geographic information systems database.
